(19) United States
(12) Patent Application Publication
(10) Pub. No.: US 2008/0130292 A1
(43) Pub. Date: Jun. 5, 2008

(54) Method For Setting The Brightness Distribution For An Illumination

(76) Inventors: Friederich Henz, Frankfurt (DE); Otto Kretzschmar, Einhausen (DE); Ulrich Pahmeyer, Babenhausen (DE); Peter Selzer, Schaafheim (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/718,691

(22) PCT Filed: Oct. 5, 2005
(86) PCT No.: PCT/EP05/54995

§ 371 Date: May 4, 2007

(30) Foreign Application Priority Data
Nov. 8, 2004 (DE) 10 2004 053 797.6

(51) Int. Cl. F21V 5/00; B29D 11/00

(52) U.S. Cl. 362/311; 264/1.24

(57) ABSTRACT

In a method for setting the brightness distribution (5) to a set distribution for an illumination of a back-lit display instrument with a display field (4), a light guide (2, 14) and a light source (1), the brightness distribution (5) is generated as an error image (7), the error image (7) is used as control information for a surface processing of a shaped insert (10) and a new light guide (14) produced with said shaped insert (10).

### CROSS-REFERENCE TO RELATED APPLICATIONS

This application is a U.S. national stage application of International Application No. PCT/EP2005/054995 filed Oct. 5, 2005, which designates the United States of America, and claims priority to German application number 10 2004 053 797.6 filed Nov. 8, 2004, the contents of which are hereby incorporated by reference in their entirety.

### TECHNICAL FIELD

The invention relates to a method for adapting the brightness distribution to a set distribution of an illumination of an illumination zone, behind which an optical waveguide is arranged, which distributes the light of at least one light source in a manner such that the illumination zone is back-lit and which has a coupling-out area, provided with a surface structure, for emitting the light.

### BACKGROUND

When illuminating an illumination zone, in particular a display zone of a surface display instrument, using a light source arranged in the region behind the display zone, brightness differences between partial regions of the display zone, which do not correspond to the set state, regularly occur. In order to ensure a good appearance and optimum readability of a display instrument, in particular in a motor vehicle, a high outlay is not shied away from. Particular problem areas with respect to inhomogeneous light distribution are regions of the display zone which lie in the direct vicinity of the back-lighting light source or of the region where light is coupled in from the light source in the optical waveguide located behind the display zone.

The following methods have essentially been used hitherto for eliminating brightness differences or deviation of the brightness distribution from a set state.

An expensive and complex solution allows for the use of more light sources, preferably LEDs.

In another solution, a printed film is arranged between the optical waveguide and a dial forming the display zone, which film is produced as a scanned negative image of a photographic image of the brightness differences, also often referred to as a defect image. However, the arrangement of a printed film has, besides the necessity of the additional component of the printed film, the disadvantage of the undesired absorption, which entails the requirement of a higher power of the light sources with corresponding average light intensity of the illumination.

A more complex method of homogenizing the illumination without the serious disadvantage of the strong absorption is to provide the optical waveguide located behind the display zone for light distribution purposes with a special structure or microstructuring of the surface in the region of the coupling-out of the light such that the amount of the coupling-out light or the light intensity can be metered in a locally targeted manner by means of the design of this structure. In order to produce the desired microstructuring, the mold insert for injection molding the optical waveguide is provided with a corresponding structure type at the locations of the coupling-out of the light from the optical waveguide. Said structure type can optionally be in the form of a nickel layer. The local distribution of the structure is in this case determined by means of a computational simulation of the optical beam path and of the resulting brightness distributions. In particular, a simulation is configured based on a CAD model and the results of the simulation are used as the basis for changing the CAD model, which is the starting point for a further simulation in the form of a time-consuming and expensive iteration, which is then followed by tests with the mold insert.

### SUMMARY

Proceeding from the problems of the prior art, it is an object of the invention to enable a less complex adaptation of the brightness distribution to a set distribution and at the same time to comply especially well with the set specifications.

According to an embodiment, a method for adapting the brightness distribution to a set distribution of an illumination of an illumination zone, behind which an optical waveguide is arranged, which distributes the light of at least one light source in a manner such that the illumination zone is back-lit and which has a coupling-out area, provided with a surface structure, for emitting the light, may comprise in a first step, producing the brightness distribution as a defect image on the basis of an arrangement comprising the illumination zone, a first optical waveguide and the light source in operation; in a second step, using the defect image as control information for surface processing by removal, reshaping or application a mold insert for injection molding a second optical waveguide, wherein the basic form of the second optical waveguide corresponds to that of the first optical waveguide, in the region of the coupling-out area; and in a third step, injection molding the second optical waveguide by means of the mold insert.

### BRIEF DESCRIPTION OF THE DRAWINGS

The invention is described in more detail below using a specific exemplary embodiment with reference to the drawings, in which:

FIGS. 1 to 6 each show a schematic illustration of various manufacturing steps in accordance with the method.

### DETAILED DESCRIPTION

The first step of this method according to an embodiment serves for producing a defect image, i.e. a brightness distribution which does not yet correspond to the set state, on the basis of an arrangement comprising the display zone, a first optical waveguide and the light source in operation. The first optical waveguide can be an individually manufactured specimen or a component produced using an unstructured insert, for example using the injection molding process. A photographic method is used for this purpose, which takes substantially less time and yields more accurate results than a computational simulation of the beam path. According to an embodiment, however, the defect image can also be produced by computational means from a simulation computation. This has the advantage that the costs for the production of the arrangement are initially saved. During a second step, according to an embodiment, the defect image to be produced is provided as control information for surface processing by removing, reshaping or applying a mold insert for injection molding a second optical waveguide, the basic form of which optical waveguide corresponds to that of the first optical waveguide in the region of the coupling-out area. The usual material-removing processing methods are suitable in principle for the removal. Preferred methods in this case are removal by means of rotating tools, for example by means of a polishing head in a milling machine. The mold insert can advantageously also be provided with the structure by means of erosion, embossing or point grinding. A nickel layer, for example, is in this case applied in a manner such that a molding surface corresponding to the desired surface structure of the optical waveguide is produced in the region of the light coupling-out from the optical waveguide. The brightness information of the defect image can in this case be used particularly expediently and still accurately, preferably in a digital manner, as control information for the surface processing. It is possible in this manner to fix for example displacement travels or distances between the embossing locations in the mold insert. The structure differences can, besides the distances, also be produced by the speed of the cutting tool or the feed rate. All those adjustment variables of the manufacturing method for the design are suitable which influence the surface structure and thus the optical properties of the moldings produced using the insert. It is expediently possible for the distance between the processing locations of the mold insert to be the smaller the more the illumination needs to be brightened based on the deviation of the defect image from the set state.

According to an embodiment, the illumination of a back-lit display instrument which has a display zone which corresponds to the illumination zone is adapted. Mostly homogeneous illumination corresponding to the set specifications is particularly important in this case.

In order to attain or approach the desired set state, in a third step, a second optical waveguide is finally injection molded by means of the reworked mold insert and ensures a more uniform brightness distribution, or compliance with the set specifications, during the operation of the display instrument.

According to an embodiment, the surface processing of the second step comprises a similar method, for example etching the mold insert according to the defect image. In this case, the defect image is expediently converted to a photographic template for etching the mold insert and the mold insert is etched in accordance with this photographic template. Finally, the surface structure of the mold insert is imaged onto the moldings by means of a molding method, for example by means of injection molding, in the third step.

The molding produced in this manner, or the improved optical waveguide, can be used again to produce a defect image in accordance with the first step of the method according to an embodiment. Starting from the defect image thus produced, the mold insert is once more subjected to a processing in accordance with the second step, with the result that an optical waveguide or a molding of an even higher operational quality is achieved in the subsequent third step.

Particular advantages of the method according to an embodiment over conventional methods can be seen mainly in the saving of a significant portion of the complexity which has previously been necessary to produce a suitable mold insert, but also in the improved operation of the optical waveguides produced using the method according to an embodiment with respect to those which have been produced in the conventional manner. The arrangement of a printed film absorbing brightness peaks can be dispensed with altogether, which considerably decreases the light power required for the illumination and leads to energy savings. On account of leaving out the film, the component diversity also decreases. Advantageously, there is no possible deviation between a computational simulation and the actual brightness distribution of the illumination.

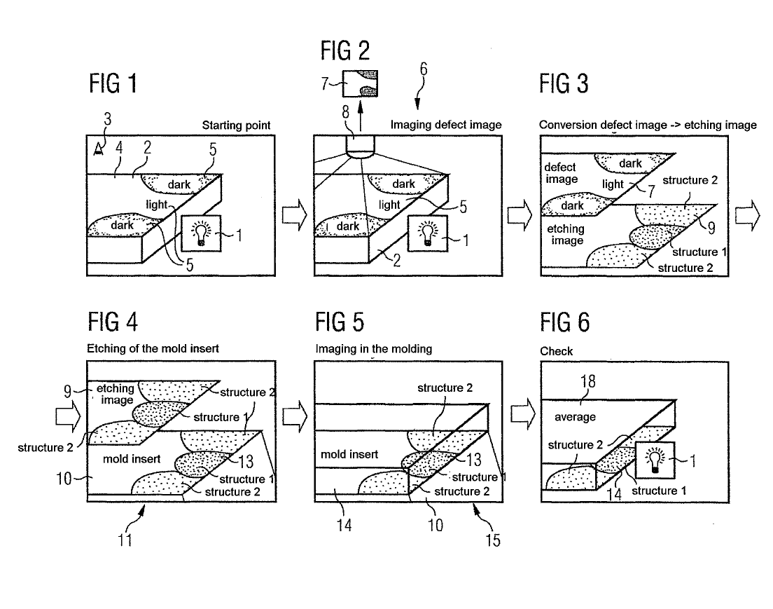

FIG. 1 shows a light source 1 and a first optical waveguide 2, on whose surface which faces a viewer 3 a display zone 4 is provided which has an inhomogeneous brightness distribution 5 deviating from a set state.

FIG. 2 shows the first step 6 of the method according to an embodiment, in which the brightness distribution 5 is recorded as defect image 7 using a recording appliance 8.

FIG. 3 shows the conversion of the recorded defect image 7 into an etching image 9.

FIG. 4 shows a mold insert 10 which is provided for injection molding the optical waveguides and into which a structure 13, which corresponds to the brightness distribution 5, is etched using the etching image 9 in accordance with a second step 11 of the method according to an embodiment.

FIG. 5 shows the imaging of the structure 13 of the mold insert 10 onto a second optical waveguide 14 injected into the mold insert 10 in accordance with a third step 15 according to an embodiment.

FIG. 6 shows the result achievable with the second optical waveguide 14 in terms of the brightness distribution 5, which, on account of the embossed or etched-in structure 13, is much closer to the set specifications than the defect image 7 which was produced initially. In a region 18, an average brightness is now obtained over the entire area, rather than the strongly inhomogeneous brightness distribution in accordance with the defect image 7 recorded initially.

What is claimed is:

1. A method for adapting the brightness distribution to a set distribution of an illumination of an illumination zone, behind which an optical waveguide is arranged, which distributes the light of at least one light source in a manner such that the illumination zone is back-lit and which has a coupling-out area, provided with a surface structure, for emitting the light, the method comprising:
in a first step, producing the brightness distribution as a defect image on the basis of an arrangement comprising the illumination zone, a first optical waveguide and the light source in operation,
in a second step, using the defect image as control information for surface processing by removal, reshaping or application a mold insert for injection molding a second optical waveguide, wherein the basic form of the second optical waveguide corresponds to that of the first optical waveguide, in the region of the coupling-out area, and
in a third step, injection molding the second optical waveguide by means of the mold insert.

2. The method according to claim 1, wherein the surface processing of the second step comprises etching the mold insert according to the defect image.

3. The method according to claim 1, wherein the first and third steps are repeated at least once, wherein the respective optical waveguide which was produced last is used to produce the defect image.

4. The method according to claim 1, wherein the defect brightness distribution is determined as a defect image using a computational means by means of computational simulation under the boundary conditions of an arrangement comprising the illumination zone, a first optical waveguide and the light source in operation.

5. The method according to claim 1, wherein the defect image is converted as a photographic template for etching the mold insert and the mold insert is etched according to this photographic template.

6. The method according to claim 1, wherein the brightness information of the defect image is used, in a digital manner, as control information of the surface processing.

7. Arrangement comprising:
a light source,
an illumination zone,
an corrected optical waveguide arranged between the light source and the illumination zone which distributes the light of the light source in a manner such that the illumination zone is back-lit and which has a coupling-out area, provided with a surface structure, for emitting the light, wherein the corrected optical waveguide is injection molded using a defect image produced by a non-corrected optical waveguide as control information for surface processing by removal, reshaping or application a mold insert, wherein the basic form of the corrected optical waveguide corresponds to that of the non-corrected optical waveguide, in the region of the coupling-out area.

8. The arrangement according to claim 7, wherein the surface processing comprises etching the mold insert according to the defect image.

9. The arrangement according to claim 7, wherein the brightness distribution is determined as a defect image using a computational means by means of computational simulation under the boundary conditions of an arrangement comprising the illumination zone, a first optical waveguide and the light source in operation.

10. The arrangement according to claim 7, wherein the defect image is converted as a photographic template for etching the mold insert and the mold insert is etched according to this photographic template.

11. The arrangement according to claim 7, wherein the brightness information of the defect image is used, in a digital manner, as control information of the surface processing.
